(19) United States
(12) Patent Application Publication
(10) Pub. No.: US 2026/0267668 A1
(43) Pub. Date: Sep. 10, 2026

(54) METHODS AND APPARATUSES FOR DISPLAYING INTERACTIVE ELEMENT, DEVICE, MEDIUM AND PROGRAM PRODUCT

(71) Applicant: Beijing Zitiao Network Technology Co., Ltd., Beijing (CN)

(72) Inventors: Ziyan LI, Beijing (CN); Haoqi WEN, Beijing (CN)

(21) Appl. No.: 19/558,084

(22) Filed: Mar. 5, 2026

(30) Foreign Application Priority Data
Mar. 5, 2025 (WO) PCT/CN2025/080759

(51) Int. Cl. G06F 9/451; G06F 3/0481

(52) U.S. Cl. CPC G06F 9/451; G06F 3/0481

(57) ABSTRACT

Embodiments of the present disclosure relate to a method and apparatus for displaying interactive element, a device, a medium and a program product. The method includes determining a target distance from a center point of an arrow of the interactive element to be displayed to an edge of a display screen, wherein the arrow is used to indicate a target object displayed in the display screen. The method further includes adjusting, in response to the target distance being smaller than a threshold distance, the arrow of the interactive element. The method further includes displaying the adjusted arrow in the display screen.

### CROSS-REFERENCE TO RELATED APPLICATION

This application claims priority to International Patent t Application No. PCT/CN2025/080759 filed in Mar. 5, 2025, the disclosure of which is incorporated herein by reference in its entity.

### FIELD

Embodiments of the present disclosure generally relate to the field of user interaction, and more specifically, to a method and apparatus for displaying an interactive element, a device, a medium and a program product.

### BACKGROUND

In a user interface, there are many interface elements, some of which are displayed to interact with user-related operations, some of which are only used to decorate the user interface, and some of which appear only after a particular operation or occurrence of a particular object, and may be displayed in association with the target object, to enhance the user experience in actual interaction process.

Nowadays, more and more attention has been paid to user interaction and aesthetically pleasing interface elements and satisfactory interaction experience are currently pursued by people. Among this, the design of the user interface has become a rather important part. An excellent user interface design can enhance the user's immersion experience and also increase the retention on the user interface. Therefore, it is of a growing importance to provide a better design for the user interface and enhance the user experience brought by such a design.

### SUMMARY

Embodiments of the present disclosure provide a method and apparatus for displaying interactive element, a device, a medium and a program product.

In accordance with a first aspect of the present disclosure, there is provided a method for displaying interactive element. The method includes determining a target distance from a center point of an arrow of the interactive element to be displayed to an edge of a display screen, wherein the arrow is used to indicate a target object displayed in the display screen. The method also includes adjusting, in response to the target distance being smaller than a threshold distance, the arrow of the interactive element. The method also includes displaying the adjusted arrow in a display screen.

In accordance with a second aspect of the present disclosure, there is provided an apparatus for displaying interactive element. The apparatus includes a target distance determining module, configured to determine a target distance from a center point of an arrow of the interactive element to be displayed to an edge of a display screen, wherein the arrow is used to indicate a target object displayed in the display screen; an arrow adjusting module, configured to adjust, in response to the target distance being smaller than a threshold distance, the arrow of the interactive element; and an arrow display module, configured to display the adjusted arrow in a display screen.

In accordance with a third aspect of the present disclosure, there is provided an electronic device, the electronic device includes at least one processor; and a storage apparatus configured to store at least one program, the at least one program, when executed by the at least one processor, causes the at least one processor to implement the method according to the first aspect of the present disclosure.

In accordance with a fourth aspect of the present disclosure, there is provided a computer-readable storage medium storing a computer program thereon, the computer program, when executed by a processor, implements the method according to the first aspect of the present disclosure.

In accordance with a fifth aspect of the present disclosure, there is provided a computer program product. The computer program product includes a computer program, the computer program, when executed by a processor, implements the method according to the first aspect of the present disclosure.

It should be appreciated that the content described in this Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for displaying an interactive element according to some embodiments of the present disclosure;

FIG. 3 illustrates a schematic diagram of an example of the interactive element and the target object for displaying an interactive element according to some embodiments of the present disclosure;

FIG. 4 illustrates a schematic diagram of an example procedure for displaying an interactive element according to some embodiments of the present disclosure;

FIG. 5 illustrates a schematic diagram of an example of Bezier curve path position information for displaying an interactive element in accordance with some embodiments of the present disclosure;

FIG. 6 illustrates a schematic block diagram of an apparatus for displaying an interactive element according to some embodiments of the present disclosure;

FIG. 7 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an option and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part-on”. The term “one-embodiment” or “this embodiment” is to be read as “at least one embodiment.” The terms “first”, “second” and so on can refer to same or different objects. The following text also may include other explicit and implicit definitions.

In user interface design, Tooltip is a common interactive element for providing context-related information to users. Usually, the Tooltip is displayed in the form of a floating bubble and is pointed to a related target element by an indicating arrow. However, some issues may occur when the Tooltip approaches edges of the screen.

For example, the indicating arrow corresponding to the Tooltip could not be correctly displayed in the user interface. Such as due to the display of the screen edge, the indicating arrow may be cut out, causing incomplete visual effects of the indicating arrow in the user interface. Besides, the indicating arrow may deviate from the target element, leading to a degraded visual feel. The Tooltip may be misplaced in the user interface. At this point, as the subject of the Tooltip may be forced to relocate due to the screen boundary limit, the relevance between the indicating arrow and the target element decreases. Therefore, it is difficult for the users to accurately understand the context of the tip and the user experience decreases significantly. The traditional processing method lacks a dynamic adjustment strategy for the screen edge situation, so the display effects of the Tooltip are inconsistent, which further impacts the user experience. Moreover, some traditional schemes cope with the screen edge issue by simply hiding the arrow or adjusting the position of the Tooltip, but still fail to provide a consistent visual solution.

To at least solve the above and other potential problems, embodiments of the present disclosure provide a method for displaying an interactive element. In this method, the computing device may first determine a target distance from a center point of an arrow of the interactive element displayed in the display screen to an edge of the display screen, wherein the arrow indicates a target object displayed in the display screen. When it is determined that the target distance is smaller than a threshold distance, the arrow of the interactive element is adjusted. In the end, the computing device indicates the target object with the adjusted arrow. The method also includes displaying the adjusted arrow in the display screen. According to this method, the display of the arrow of the interactive element in the user interface may be adjusted according to a distance from the arrow of the interactive element to the edge of the display screen, so as to ensure integrity of the arrow of the interactive element. Further, the arrow may always point to the target object normally and the user experience is therefore enhanced.

It is to be understood that the present disclosure is described only with reference to related embodiments, but the protection scope of the present disclosure should not be restricted by the related embodiments. Any technical solutions in other disclosure should also be protected as long as they fall within the claimed protection scope.

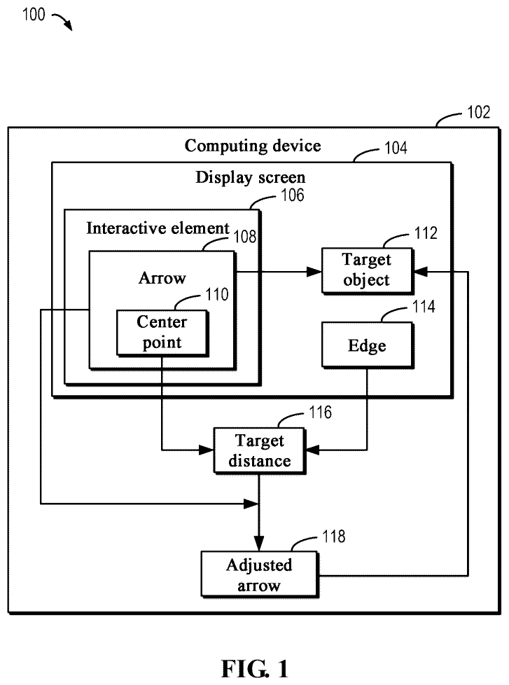

Embodiments of the present disclosure are to be described in details below with reference to the drawings, wherein FIG. 1 illustrates an example environment in which the device and/or method of the embodiments of the present disclosure may be implemented. In the environment 100, the computing device 102 is used to process computation tasks required to be executed at the display of the interactive elements. The interactive element is associated with a target object, the target object may include any suitable information, such as user input content. And the interactive element may be employed to display the prompt content related to the target object. For example, when input content is present in the target object, the interactive element is displayed on the user interface. Additionally, when the target object is present in the user interface, the interactive element associated with the target object is always displayed on the user interface.

Examples of the computing device 102 include, but not limited to, personal computer, server computer, hand-held or laptop device, mobile device (e.g., mobile phone, Personal Digital Assistant (PDA), and media player etc.), multi-processor system, consumer electronic product, minicomputer, large-scale computer, and a distributed computing environment including any of the above systems or devices.

As shown in FIG. 1, the computing device 102 may display the target object 112 in the display screen 104. For example, the target object may be any suitable display information, such as displayed file, displayed image or displayed component. To further display some related information for the target object 112, e.g., prompt information for the target object, the interactive element 106 having an arrow 108 may be used.

Prior to the display of the interactive element 106, the computing device 102 may first determine a target distance 116 from a center point 110 of the arrow 108 of the interactive element 106 to be displayed in the display screen 104 to the edge 114 of the display screen 104, wherein the arrow 108 is used to indicate the target object 112 displayed on the display screen 104.

It is to be explained that the interactive element 106 may be in the form of a floating arrow indication bubble, and other types of interactive elements having an arrow may also be employed. The present disclosure is not restricted in this regard.

When there is an ongoing activity in the user interface, e.g., the user is inputting a text, the target object 112 may be an input box for receiving the user input. At this point, the interactive element 106 may be a floating arrow indication bubble for the target object 112. In one example, the floating arrow indication bubble may be used to display the prompt text information corresponding to the input text in the input box. In another example, the floating arrow indication bubble may be used to display the image information corresponding to the input text in the input box. In a further example, the floating arrow indication bubble may be used to display multi-modal information corresponding to the input text in the input box (e.g., text information, image information and audio information etc.).

Besides, the center point of the arrow 108 of the interactive element 106 to be displayed should be positioned on a center line of the target object 112. For example, the center point of the arrow of the floating arrow indication bubble may be positioned on a center line of the input box.

For example, when the length of the input box changes, e.g., the length of the input box increases, the center point of the input box will move. The center point of the arrow of the floating arrow indication bubble also moves along with the movement of the center point of the input box, such that the two center points are always kept on the same straight line.

In one example, the computing device 102 may take the distance from the center point of the arrow of the interactive element 106 or the center point of the target object 112 to the edge 114 of the display screen 104 as the target distance 116 from the center point of the arrow of the interactive element 106 to the edge 114 of the display screen 104.

In another example, after the center point of the arrow of the interactive element 106 to be displayed and the center point of the target object 112 are determined, the computing device 102 also may first determine a straight line connecting the two center points and then decide the target distance 116 from the center point of the arrow of the interactive element 106 to the edge 114 of the display screen 104 in accordance with a distance from the determined straight line to the edge 114 of the display screen 104.

It is to be understood that the target distance 116 from the center point of the arrow of the interactive element 106 to the edge 114 of the display screen 104 is within a certain range, and the range of the distance may be self-defined by the user.

To display the arrow of the interactive element in consistent with the target object, the computing device 102 would determine, in accordance with the target distance, whether to adjust the arrow of the interactive element to be displayed. At this point, the computing device 102 may compare the target distance with a predetermined threshold distance. When the computing device 102 determines that the target distance 116 is greater than or equal to the threshold distance, it is indicated that the distance at this point is large enough not to affect the normal display of the arrow. Therefore, the center point of the arrow is aligned with the center point of the target object 112 only by moving several control points of the arrow 108 of the interactive element 106 to be displayed. When the computing device 102 determines that the target distance 116 is smaller than the threshold distance, the arrow 108 of the interactive element 106 is adjusted.

It should be particularly noted that the numerical unit of the distance, such as target distance and threshold distance etc., may be a specific unit, e.g., millimeter (mm), and also may indicate a display unit. Each display unit may include one or more pixels, e.g., three pixels. It is to be appreciated that the length of the threshold distance may be set by the user in view of the actual situations. For example, the threshold distance may be set to be 26 display units.

In a possible scenario, a plurality of different threshold distances may be configured. For example, the above threshold distance may be referred to as a first threshold distance. There may also be a second threshold distance and a third threshold distance etc. Additionally, a plurality of threshold distances may be unequal and a plurality of threshold distances may constitute at least one set of range interval according to the size of the value.

For example, it is configured that the first threshold distance is 26, the second threshold distance is 20 and a third threshold distance is 10. At this point, the first threshold distance, the second threshold distance and the third threshold distances may form two sets of range intervals, i.e., a range interval from 20 to 26 and a range interval from 10 to 20. Additionally, the range interval may be an open interval.

After determining the target distance 116, the computing device 102 may compare the target distance 116 with the first threshold distance, the second threshold distance or the third threshold distance, so as to adjust the arrow 108 of the interactive element 106 in accordance with the comparison between the target distance 116 and the threshold distance of a plurality of threshold distances.

After adjusting the arrow 108 of the interactive element 106 in accordance with the comparison between the target distance 116 and the threshold distance of a plurality of threshold distances, the computing device 102 obtains the adjusted arrow 118. Afterwards, the computing device 102 displays the adjusted arrow 118 in the display screen to indicate the target object 112.

According to this method, the display of the arrow of the interactive element in the user interface may be adjusted according to a distance from the arrow of the interactive element to the edge of the display screen, so as to ensure integrity of the arrow of the interactive element. Further, the arrow may always point to the target object normally and the user experience is therefore enhanced.

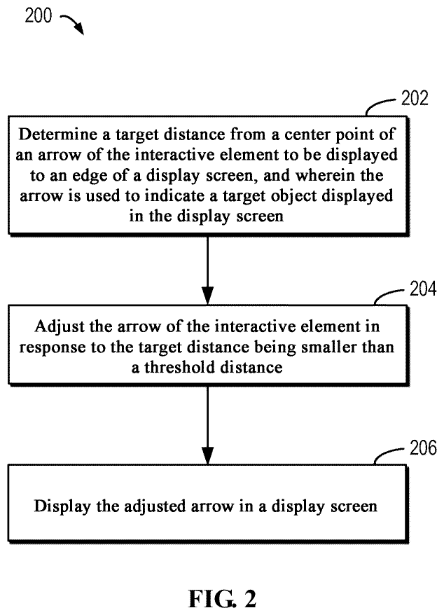

The schematic diagram of the example environment in which the device and/or method according to some embodiments of the present disclosure may be implemented has been described above with reference to FIG. 1. Next, a schematic diagram of an example method 200 for displaying an interactive element according to some embodiments of the present disclosure is to be depicted below with reference to FIG. 2. The example method may be executed by the computing device 102 in FIG. 1 and/or any suitable computing devices.

As shown in FIG. 2, in the example method 200, at block 202, the computing device 102 determines the target distance from the center point of the arrow of the interactive element to be displayed to the edge 114 of the display screen, and wherein the arrow is used to indicate the target object displayed in the display screen.

In some embodiments, in case that the target object 112 is arranged at the edge of the display screen, the edge of the interactive element 106 to be displayed, the edge of the target object 112 and the edge 114 of the display screen may be on the same straight line, for aesthetics of interface display.

In some embodiments, the arrow 108 of the interactive element 106 to be displayed is used to indicate the target object 112. For example, the arrow in the floating arrow indication bubble indicates an input box as the target object. It is to be understood that the interactive element 106 is associated with the target object 112 and the arrow 108 changes with the variations of the target object 112 and the interactive element 106. For example, the arrow 108 moves in a horizontal direction as the length of the target object 112 and the interactive element 106 changes. In addition, the arrow 108 may also be correspondingly adjusted.

Next, at block 204, the arrow of the interactive element is adjusted in response to the target distance being smaller than the threshold distance. For a better match between the interactive element and the target object, e.g., to ensure that the center point of the arrow of the interactive element is on the center line of the target object, it is required to decide whether the target distance is too close to the edge of the display screen; if the target distance is too close to the edge of the display screen, it is required to adjust the arrow of the interactive element. In such case, a threshold distance may be configured to indicate whether the arrow of the interactive element should be adjusted. To facilitate description, the threshold distance may also be known as a first threshold distance.

After the computing device 102 determines the target distance 116 and the first threshold distance, it is required to compare the target distance 116 with the first threshold distance. In some embodiments, when it is determined that the target distance 116 is smaller than the first threshold distance, the computing device 102 adjusts the arrow of the interactive element. For example, a parameter of the arrow, such as position, direction, width or height, is adjusted, such that the center point of the arrow is positioned on the center line of the target object.

In some embodiments, when it is determined that the target distance 116 is smaller than the first threshold distance, it is further required to determine whether the target distance 116 is greater than a second threshold distance. In other words, it is required to determine whether a value of the target distance 116 falls within an interval between the first threshold distance and the second threshold distance. In addition, the interval is an open interval excluding numerical values of the two end points.

In some embodiments, the first threshold distance may be set to 26 and the second threshold distance may be set to 20. After the computing device 102 decides that the target distance 116 is greater than the second threshold distance, e.g., the target distance is within an interval range of (20, 26), the arrow 108 of the interactive element 106 is adjusted. For example, the computing device 102 may calculate a first target position for a control point of a tip of the arrow 108 and a second target position for an end point of the arrow, and then adjust the shape and the direction of the arrow 108 using the control point located at the first target position and the end point located at the second target position.

It is to be explained that the arrow 108 may be defined by a Bezier curve. Therefore, the adjustments made to the shape and the direction of the arrow 108 are also implemented via the Bezier curve.

For example, the arrow 108 is formed by the Bezier curve. The Bezier curve includes a start point and an end point, and the control points for the start point and the end point are also on the Bezier curve. The start point and the end point of the Bezier curve may be further controlled by adjusting the control points on the Bezier curve, so as to adjust the shape and the direction of the arrow 108.

Additionally, the arrow 108 may be formed by two Bezier curves, wherein the end point of one Bezier curve and the start point of the other Bezier curve collectively form the tip of the arrow 108, whereas the start point of one Bezier curve is the start point of the arrow 108 and the end point of the other Bezier curve is the end point of the arrow 108. At this point, the width of the arrow 108 is a sum of the widths of the two Bezier curves. The height of the arrow 108 may be determined using the start point and the end point of any of the Bezier curve and the tip of the arrow 108.

The computing device 102 also may further calculate a first position of the control point for the tip of a first reference arrow corresponding to the first threshold distance and a second position of the control point for the tip of a second reference arrow corresponding to the second threshold distance. For example, the first position may be indicated by P₂₆ and the second position may be denoted by P₂₀. Afterwards, the computing device 102 may further determine the first target position using the determined first position P₂₆ and the second position P₂₀. After calculating the first target position, the second target position for the end point of the arrow 108 may be further determined with reference to the width and the height of the arrow 108.

After the determination of the first target position and the second target position, the computing device 102 may adjust the shape and the direction of the arrow 108 using the control point located at the first target position and the end point located at the second target position.

In some embodiments, when the computing device 102 determines that the target distance 116 is equal to the second threshold distance, for example, the target distance 116 is equal to 20, a path of the arrow 108 may be determined as a preset first fixed path.

In some embodiments, when the computing device 102 determines that the target distance 116 is smaller than the second threshold distance and greater than the third threshold distance, the third threshold distance for example being 10, the target distance 116 is within the interval of (10, 20) at this point. The computing device 102 would gradually decrease the width and the height of the arrow 108 and further determine the third target position for the control point of the arrow 108.

For example, the computing device 102 may first determine a point position of the control point for the tip of a third reference arrow corresponding to the third threshold distance, wherein the determined third position may be represented by P₁₀. Then, the computing device 102 determines a third target position for the arrow 108 based on the second position and the third position. After the third target position is calculated, the shape and the size of the arrow 108 may be further adjusted with reference to the third target position, and the decreased width and height of the arrow 108.

In some embodiments, when the computing device 102 determines that the target distance 116 is equal to the third threshold distance, for example, the target distance 116 is equal to 10, the path of the arrow 108 may be determined as a preset second fixed path. If the computing device 102 determines that the target distance 116 is smaller than the third threshold distance, the operation of displaying the interactive element may not be executed. Alternatively, if the computing device 102 determines that the target distance 116 is smaller than the third threshold distance, the size and the width of the arrow may be further decreased for further adjustments.

In some embodiments, when the target distance 116 is greater than or equal to the first threshold distance, e.g., the target distance is greater than or equal to 26, the arrow 108 is moved only by moving a plurality of control points of the first reference arrow corresponding to the first threshold distance, and the height and the width of the arrow 108 remain the same during the movement.

In some embodiments, when the target distance 116 is equal to one of the first threshold distance, the second threshold distance and the third threshold distance, the preset fixed path may be provided.

In the end, at block 206, the computing device 102 displays the adjusted arrow in the display screen. After the arrow is determined, the interactive element and the arrow of the interactive element may be drawn to allow the arrow to indicate the target object. When the arrow 108 changes with the variation of the target distance 116, the tip of the arrow 108 maintains to indicate the target object 112.

In some embodiments, when the target distance 116 changes with the interactive element 106 or the target object 112, the position where the tip of the arrow 108 is located is constantly on the straight line formed by the center point of the floating arrow indication bubble and the center point of the target object.

According to this method, the display of the arrow of the interactive element in the user interface may be changed according to a distance from the arrow of the interactive element to the edge of the display screen, so as to ensure integrity of the arrow of the interactive element. Further, the arrow may always point to the target object normally and the user experience is therefore enhanced.

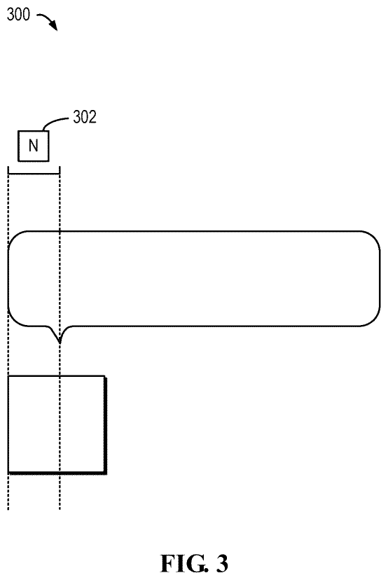

The schematic diagram of the example method for displaying an interactive element in accordance with some embodiments of the present disclosure has been described above with reference to FIG. 2. Next, a schematic diagram of an example of the interactive element and the target object for displaying an interactive element in accordance with some embodiments of the present disclosure is to be depicted in conjunction with FIG. 3.

As shown by the example 300 of FIG. 3, the input box is the target object and the floating arrow indication bubble is the interactive element. It can be seen that the center point of the target object and the center point of the floating arrow indication bubble are on the same straight line, and a left edge of the target object and a left edge of the floating arrow indication bubble are on the same straight line. In addition, the left edge of the target object, the left edge of the floating arrow indication bubble and the left edge of the display screen are on the same straight line.

The computing device 102 may determine the target distance n 302 in accordance with the line on which the edge of the display screen is positioned and the straight line on which the center point of the arrow of the floating arrow indication bubble is positioned, and correspondingly adjust the arrow in the floating arrow indication bubble when the target distance n 302 changes.

In some embodiments, when an input text is present in the input box below, the floating arrow indication bubble is displayed above the input box. Additionally, when the input box below contains no input texts, the floating arrow indication bubble above the input box is not displayed.

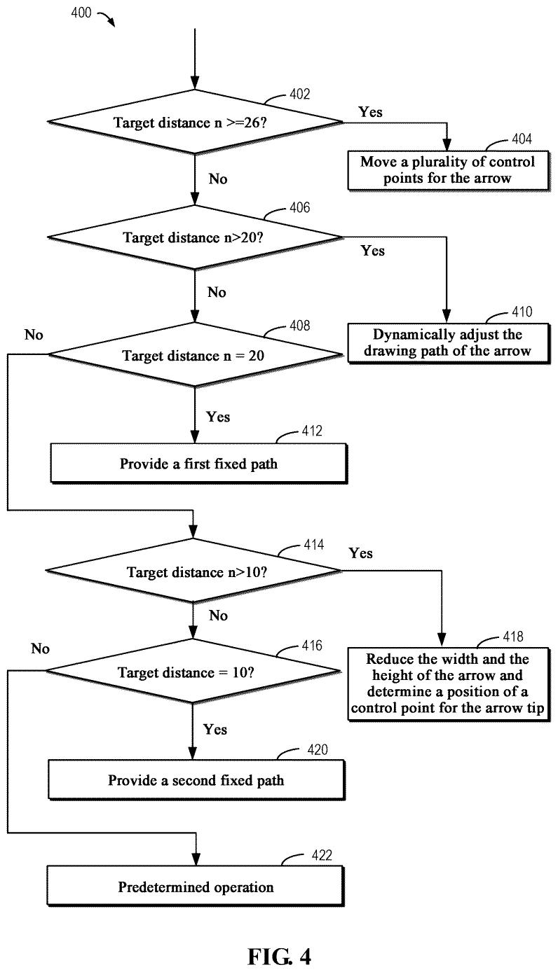

The schematic diagram of the example of the interactive element and the target object for displaying an interactive element in accordance with some embodiments of the present disclosure has been described above with reference to FIG. 3. Next, a schematic diagram of an example procedure for displaying interactive elements in accordance with some embodiments of the present disclosure is to be depicted in conjunction with FIG. 4. The example procedure may be executed by the computing device 102 in FIG. 1 or any suitable devices.

In the example procedure 400, the target distance n shown by FIG. 3 is utilized. The computing device 102 would first determine, at block 402, whether the target distance n is greater than or equal to 26, wherein the value of 26 is display unit and each display unit may be one or more pixels. If the target distance is greater than or equal to 26, a plurality of control points for the arrow may be moved at block 404. At this point, since the center point of the arrow is far from the edge of the screen display, the width and the height of the arrow remain unchanged. For example, the width may be configured to be 13 and the height may be set to 8. Additionally, the path of the arrow tip may be defined by the Bezier curve; the start point is at the left side of the arrow and the end point is at the right side of the arrow.

If the target distance n is smaller than 26, it is further determined at block 406 whether the target distance n is greater than 20. If the target distance n is greater than 20, the computing device 102 would dynamically adjust the drawing path of the arrow at block 410, to adapt to the screen edge limit. In such case, the control point of the arrow tip may be calculated according to the following Equation (1):

$${P}_{n} = {P}_{26} - \frac{( {P}_{26} - {P}_{20} ) ( 26 - n )}{26 - 20} \qquad ( 1 )$$

wherein n indicates the target distance 116; and P₂₆ and P₂₀ respectively are coordinates of path points or control points when n=26 or n=20. After the position of the control point is calculated, the position of the end point of the arrow may be further determined with reference to the width and the height of the arrow 108.

At block 408, it is further determined whether the target distance n is equal to 20. If the target distance n is equal to 20, the first fixed path is provided to the arrow at block 412, wherein the first fixed path is preset.

If the target distance n is smaller than 20, it is further determined at block 414 whether the target distance n is greater than 10. If the target distance is greater than 10, the width and the height of the arrow are reduced at block 418, to adapt to smaller screen edge; and the position of the control point for the arrow tip is determined. A coordinate of the control point of the arrow tip may be calculated by the following Equation (2):

$${P}_{n}^{′} = {P}_{20} - \frac{( {P}_{20} - {P}_{10} ) ( 20 - n )}{20 - 10} \qquad ( 2 )$$

wherein n indicates the target distance 116; and P₁₀ and P₂₀ respectively are coordinates of path points or control points when n=10 or n=20. After the position is calculated, the shape and the size of the arrow 108 may also be further adjusted with reference to the position and the decreased width and height of the arrow 108. If the target distance is not greater than 10, it is determined at block 416 whether the target distance n is equal to 10. If the target distance n is equal to 10, the second fixed path is provided to the arrow at block 420. The second fixed path is a preset path for the target distance. If the target distance n is smaller than 10, a predetermined operation is executed at block 422. For example, it is not allowed to display the arrow or the interactive element when the target distance is smaller than 10.

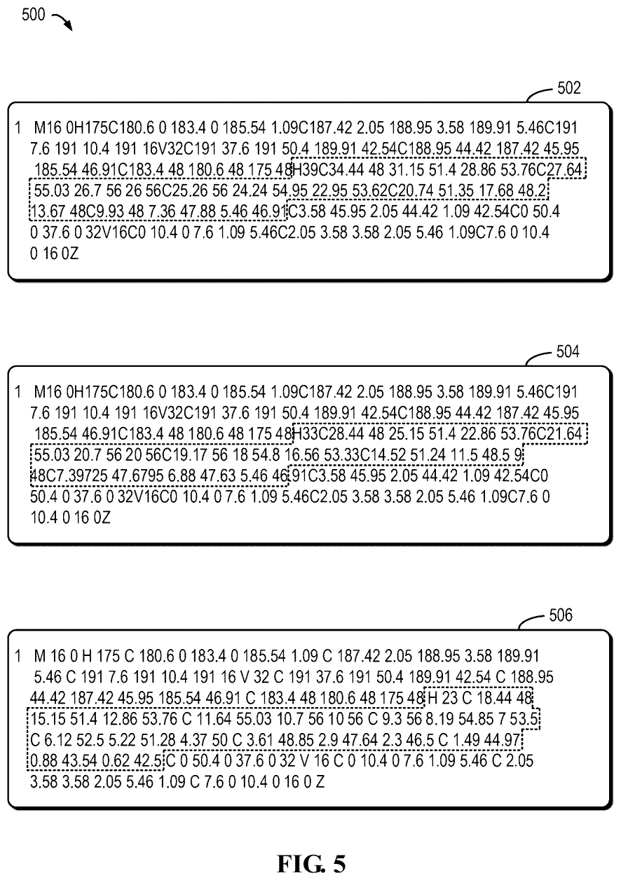

Next, a schematic diagram of an example of Bezier curve path position information for displaying an interactive element in accordance with some embodiments of the present disclosure is to be depicted in conjunction with FIG. 5. As shown by the example 500 in FIG. 5, the first threshold distance is 26, the second threshold distance is 20 and the third threshold distance is 10. The position information of the Bezier curve path may be used to determine the start point position information, the end point position information, the control point position information and the arrow tip position information of the arrow, and may also be further used to determine the height and the width of the arrow.

The Bezier curve path position information corresponding to when the target distance is the first threshold distance of 26 is illustrated in block 502, wherein the position coordinate information in a dashed box corresponds to the path information of the arrow.

When the target distance begins to change, e.g., decrease, the Bezier curve path position information in the dashed box would dynamically change. When the target distance decreases to the second threshold distance of 20, the Bezier curve path position information in the dashed box is changed to the Bezier curve path position information corresponding to when the target distance is the second threshold distance of 20 as shown in block 504. The position coordinate information in the dashed box corresponds to the path information of the arrow of this time.

The target distance may further decrease, e.g., when the target distance decreases to 10, as shown in block 506, the Bezier curve path position information in the dashed box is changed to the Bezier curve path position information corresponding to when the target distance is the third threshold distance of 10. The position coordinate information in the dashed box corresponds to the path information of the arrow of this time.

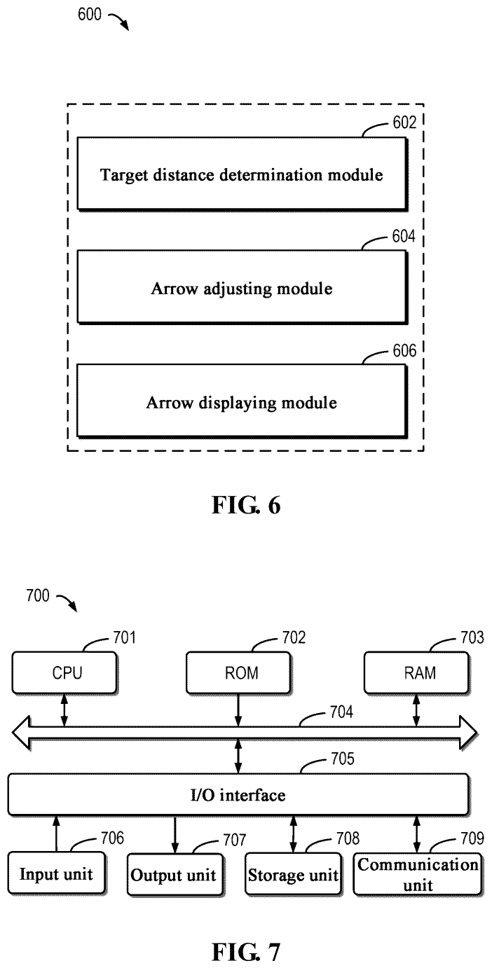

As shown in FIG. 6, the apparatus 600 includes a target distance determination module 602, configured to determine a target distance from a center point of an arrow of the interactive element to be displayed to an edge of a display screen, wherein the arrow is used to indicate a target object displayed in the display screen; an arrow adjusting module 604, configured to adjust, in response to the target distance being smaller than a threshold distance, the arrow of the interactive element; and an arrow display module 606, configured to display the adjusted arrow in the display screen.

In some embodiments, wherein the threshold distance is a first threshold distance, and the arrow adjusting module 604 includes: a target distance determination module, configured to determine whether the target distance is greater than a second threshold distance, wherein the second threshold distance is smaller than the first threshold distance; a module for determining first target position and second target position, configured to determine, in response to the target distance being greater than the second threshold distance, a first target position for a control point of a tip of the arrow and a second target position for an end point of the arrow; and a module for adjusting shape and direction of arrow, configured to adjust shape and direction of the arrow using the control point located at the first target position and the end point located at the second target position.

In some embodiments, the module for determining first target position and second target position includes: a module for determining first position and second position, configured to determine a first position of a control point for a tip of a first reference arrow corresponding to the first threshold distance and a second position of a control point for a tip of a second reference arrow corresponding to the second threshold distance; a first target position determination module, configured to determine the first target position based on the first position and the second position; and a second target position determination module, configured to determine the second target position based on the first target position and a width and a height of the arrow.

In some embodiments, wherein the arrow is defined by a Bezier curve and the control point and the end point are located on the Bezier curve.

In some embodiments, the arrow adjusting module 604 also includes: a module for determining first fixed path, configured to determine, in response to the target distance being equal to the second threshold distance, a path of the arrow as a first fixed path.

In some embodiments, the arrow adjusting module 604 also includes: the target distance determination module, configured to determine, in response to the target distance being smaller than the second threshold distance, whether the target distance is greater than a third threshold distance, wherein the third threshold distance is smaller than the second threshold distance; a module for decreasing width and height of arrow, configured to decrease, in response to the target distance being greater than the third threshold distance, the width and the height of the arrow; and a third target position determination module, configured to determine a third target position for the control point of the tip of the arrow.

In some embodiments, the third target position determination module includes: a third position determination module, configured to determine a third position of a control point for a tip of a third reference arrow corresponding to the third threshold distance; and a third target position determination module, configured to determine the third target position based on the second position and the third position.

In some embodiments, the arrow adjusting module 604 also includes: a second fixed path determination module, configured to determine, in response to the target distance being equal to the third threshold distance, the path of the arrow as a second fixed path.

In some embodiments, the apparatus 600 also includes: a module for maintaining width and height of arrow, configured to maintain, in response to the target distance being greater than or equal to the threshold distance, a width and a height of the arrow unchanged; and a module for moving a plurality of control points, configured to move a plurality of control points for the arrow based on the target distance.

In some embodiments, wherein the interactive element is a floating arrow indication bubble, and the center point of the floating arrow indication bubble and a center point of the target object are on a same straight line.

FIG. 7 illustrates a schematic block diagram of an example device 700 for implementing embodiments of the present disclosure. The computing device 102 in FIG. 1 may be implemented by the device 700. As shown in FIG. 7, the device 700 includes a central process unit (CPU) 701, which can execute various suitable actions and processing based on the computer program instructions stored in the read-only memory (ROM) 702 or computer program instructions loaded in the random-access memory (RAM) 703 from the storage unit 708. The RAM 703 can also store all kinds of programs and data required by the operation of the device 700. CPU 701, ROM 702 and RAM 703 are connected to each other via a bus 704. The input/output (I/O) interface 705 is also connected to the bus 704.

A plurality of components in the device 700 is connected to the I/O interface 705, including: an input unit 706, such as keyboard, mouse and the like; an output unit 707, e.g., various kinds of display and loudspeakers etc.; a storage unit 708, such as disk and optical disk etc.; and a communication unit 709, such as network card, modem, wireless transceiver and the like. The communication unit 709 allows the device 700 to exchange information/data with other devices via the computer network, such as Internet, and/or various telecommunication networks.

The above described procedure and processing, such as method 200 and examples 300-500, can be executed by the processing unit 701. For example, in some embodiments, method 200 and examples 300-500 can be implemented as a computer software program tangibly included in the machine-readable medium, e.g., storage unit 708. In some embodiments, the computer program can be partially or fully loaded and/or mounted to the apparatus 700 via ROM 702 and/or communication unit 709. When the computer program is loaded to RAM 703 and executed by the CPU 701, one or more actions of the above described example method 200 and examples 300-500.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or go the external computer (e.g., connected via Internet using the Internet service provider). In some embodiments, state information of the computer-readable program instructions is used to customize an electronic circuit, e.g., programmable logic circuit, field programmable gate array (FPGA) or programmable logic arrow (PLA). The electronic circuit can execute computer-readable program instructions to implement various aspect of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions includes an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

1. A method for displaying an interactive element, comprising:
determining a first distance from a center point of an arrow of the interactive element to be displayed to an edge of a display screen, the arrow being configured to indicate a first object displayed in the display screen; adjusting, in response to the first distance being smaller than a threshold distance, the arrow of the interactive element; and
displaying the adjusted arrow in the display screen.

2. The method of claim 1, wherein the threshold distance is a first threshold distance, and adjusting the arrow of the interactive element comprises:
determining whether the first distance is greater than a second threshold distance, the second threshold distance being smaller than the first threshold distance;
determining, in response to the first distance being greater than the second threshold distance, a fourth position for a control point of a tip of the arrow and a fifth position for an end point of the arrow; and
adjusting shape and direction of the arrow using the control point located at the fourth position and the end point located at the fifth position.

3. The method of claim 2, wherein determining the fourth position for the control point of the tip of the arrow and the fifth position for the end point of the arrow comprises:
determining a first position of a control point for a tip of a first reference arrow corresponding to the first threshold distance and a second position of a control point for a tip of a second reference arrow corresponding to the second threshold distance;
determining the fourth position based on the first position and the second position; and determining the fifth position based on the fourth position and a width and a height of the arrow.

4. The method of claim 3, wherein the arrow is defined by a Bezier curve, and the control point and the end point are located on the Bezier curve.

5. The method of claim 3, wherein adjusting the arrow of the interactive element further comprises: determining, in response to the first distance being equal to the second threshold distance, a path of the
arrow as a first fixed path.

6. The method of claim 3, wherein adjusting the arrow of the interactive element further comprises: determining, in response to the first distance being smaller than the second threshold distance, whether
the first distance is greater than a third threshold distance, the third threshold distance being smaller than the second threshold distance;
decreasing, in response to the first distance being greater than the third threshold distance, the width and the height of the arrow; and
determining a sixth position for the control point of the tip of the arrow.

7. The method of claim 6, wherein determining the sixth position for the control point of the tip of the arrow comprises:
determining a third position of a control point for a tip of a third reference arrow corresponding to the third threshold distance; and
determining the sixth position based on the second position and the third position.

8. The method of claim 6, wherein adjusting the arrow of the interactive element further comprises: determining, in response to the first distance being equal to the third threshold distance, the path of the
arrow as a second fixed path.

9. The method of claim 1, further comprising:
maintaining, in response to the first distance being greater than or equal to the threshold distance, a width and a height of the arrow unchanged; and
moving a plurality of control points for the arrow based on the first distance.

10. The method of claim 1, wherein the interactive element is a floating arrow indication bubble, and the center point of the floating arrow indication bubble and a center point of the first object are on a same straight line.

11. An electronic device, comprising:
at least one processor; and
a storage apparatus, configured to store at least one program, wherein the at least one program, when executed by the at least one processor, causes the at least processor to:
determine a first distance from a center point of an arrow of the interactive element to be displayed to an edge of a display screen, the arrow being configured to indicate a first object displayed in the display screen; adjust, in response to the first distance being smaller than a threshold distance, the arrow of the interactive element; and
display the adjusted arrow in the display screen.

12. The electronic device according to claim 11, wherein the threshold distance is a first threshold distance, and the at least one program causing the at least processor to adjust the arrow of the interactive element further causes the at least processor to:
determine whether the first distance is greater than a second threshold distance, the second threshold distance being smaller than the first threshold distance;
determine, in response to the first distance being greater than the second threshold distance, a fourth position for a control point of a tip of the arrow and a fifth position for an end point of the arrow; and
adjust shape and direction of the arrow using the control point located at the fourth position and the end point located at the fifth position.

13. The electronic device according to claim 12, wherein the at least one program causing the at least processor to determine the fourth position for the control point of the tip of the arrow and the fifth position for the end point of the arrow further causes the at least processor to:
determine a first position of a control point for a tip of a first reference arrow corresponding to the first threshold distance and a second position of a control point for a tip of a second reference arrow corresponding to the second threshold distance;
determine the fourth position based on the first position and the second position; and determine the fifth position based on the fourth position and a width and a height of the arrow.

14. The electronic device according to claim 13, wherein the arrow is defined by a Bezier curve, and the control point and the end point are located on the Bezier curve.

15. The electronic device according to claim 13, wherein the at least one program further causes the at least processor to:
determine, in response to the first distance being equal to the second threshold distance, a path of the arrow as a first fixed path.

16. The electronic device according to claim 13, wherein the at least one program causing the at least processor to adjust the arrow of the interactive element further causes the at least processor to:
determine, in response to the first distance being smaller than the second threshold distance, whether the first distance is greater than a third threshold distance, the third threshold distance being smaller than the second threshold distance;
decrease, in response to the first distance being greater than the third threshold distance, the width and the height of the arrow; and
determine a sixth position for the control point of the tip of the arrow.

17. The electronic device according to claim 16, wherein the at least one program causing the at least processor to determine the sixth position for the control point of the tip of the arrow further causes the at least processor to:
determine a third position of a control point for a tip of a third reference arrow corresponding to the third threshold distance; and
determine the sixth position based on the second position and the third position.

18. The electronic device according to claim 16, wherein the at least one program causing the at least processor to adjust the arrow of the interactive element further causes the at least processor to:
determine, in response to the first distance being equal to the third threshold distance, the path of the arrow as a second fixed path.

19. The electronic device according to claim 11, wherein the at least one program further causes the at least processor to:
maintain, in response to the first distance being greater than or equal to the threshold distance, a width and a height of the arrow unchanged; and
move a plurality of control points for the arrow based on the first distance.

20. A non-transitory computer-readable storage medium storing a computer program thereon, wherein the computer program, when executed by a processor, causes the processor to:
determine a first distance from a center point of an arrow of the interactive element to be displayed to an edge of a display screen, the arrow being configured to indicate a first object displayed in the display screen;
adjust, in response to the first distance being smaller than a threshold distance, the arrow of the interactive element; and
display the adjusted arrow in the display screen.
